(19) United States
(12) Patent Application Publication
(10) Pub. No.: US 2024/0367618 A1
(43) Pub. Date: Nov. 7, 2024

(54) ROOF MODULE FOR FORMING A VEHICLE ROOF HAVING A CLEANING NOZZLE

(71) Applicant: Webasto SE, Stockdorf (DE)

(72) Inventors: Maximilian EHRMANN, Stockdorf (DE); Dirk AUERSWALD, Stockdorf (DE); Alexander KILIAS, Stockdorf (DE); Cèdric LANGLAIS, Stockdorf (DE)

(21) Appl. No.: 18/686,986

(22) PCT Filed: Aug. 2, 2022
(86) PCT No.: PCT/EP2022/071709

§ 371 Date: Feb. 27, 2024

(30) Foreign Application Priority Data
Sep. 3, 2021 (DE) 10 2021 122 871.9

(51) Int. Cl. B60S 1/52

(52) U.S. Cl. CPC B60S 1/528; B60Y 2400/301

(57) ABSTRACT

A roof module for forming a vehicle roof on a motor vehicle, the roof module has a panel component, which at least partially forms a roof skin of the vehicle roof, the roof skin serving as an outer sealing surface of the roof module; at least one 5 environment sensor configured to send and/or receive electromagnetic signals through a see-through area so as to detect a vehicle environment; and at least one cleaning nozzle configured to clean the see-through area. At least one flow guiding element is disposed on the panel component, the flow guiding element being configured to deflect headwind away from the see-through area.

### CROSS-REFERENCE TO RELATED APPLICATIONS

This application is a U.S. national phase application filed under 35 U.S.C. § 371 of International Application No. PCT/EP2022/071709, filed on Aug. 2, 2022, published under WO 2023/030810A1 on Mar. 9, 2023, designating the United States, which claims priority from German Patent Application Number 10 2021 122 871.9, filed on Sep. 3, 2021, which are hereby incorporated herein by reference in their entirety.

### FIELD

The invention relates to a roof module for forming a vehicle roof on a motor vehicle according to the preamble of claim 1.

### BACKGROUND

Generic roof modules are used extensively in vehicle construction, as these roof modules can be prefabricated as separate functional modules and delivered to the assembly line when the vehicle is assembled. The roof module at least partially forms a roof skin of the vehicle roof at its outer surface, the roof skin preventing moisture or air flows from entering the vehicle interior. The roof skin is formed by one or more panel components, which can be made of a stable material, such as painted sheet metal or painted or died-through plastic. The roof module can be part of a rigid vehicle roof or part of an openable roof assembly.

Furthermore, developments in vehicle construction are increasingly focusing on autonomous or semi-autonomous motor vehicles. In order to enable the vehicle control system to control the motor vehicle autonomously or semi-autonomously, a plurality of environment sensors (e.g., lidar sensors, radar sensors, (multi-) cameras, etc. together with other (electrical) components) are used, which are integrated into the roof module, detect the environment around the motor vehicle, for example, and determine a current traffic situation, for example, from the detected environmental data. Roof modules which are equipped with a plurality of environment sensors are also known as roof sensor modules (RSM). The known environment sensors send and/or receive suitable electromagnetic signals, such as laser beams or radar beams, allowing a data model of the vehicle environment to be generated by suitable signal evaluation and to be used for controlling the vehicle.

The environment sensors for monitoring and detecting the vehicle environment are usually attached to the vehicle roof, as the vehicle roof is usually the highest point of a vehicle, from which the vehicle environment is clearly visible. The environment sensors are usually mounted as an attachment on top of the panel component of the roof module forming the roof skin but can alternatively also be disposed in an opening of the roof module in such a manner that they can be moved between a retracted position and a deployed position.

During use of the environment sensor, there is a risk that a (partially) transparent see-through area, through which the environment sensor detects the vehicle environment, may become dirty or opaque for the environment sensor due to environmental influences (e.g., weather conditions). To clean the see-through area, the use of cleaning nozzles is known, by means of which the see-through area can be cleaned. Similar to the spray nozzles of a windshield wiper system, the known cleaning nozzles are usually disposed statically in an area of the roof module or the panel component which is located in front of the environment sensor when viewed in the direction of its optical axis. In principle, the cleaning nozzles can be disposed in the field of view of the environment sensor or outside the field of view, a position outside the field of view being desirable for the accuracy of detection of the environment sensor.

The known cleaning devices typically comprise at least one cleaning nozzle through which a fluid cone for cleaning the see-through area can be produced with a cleaning fluid, for example a liquid or a gas (such as compressed air). The cleaning fluid is usually pressurized to a pressure of 2 to 3 bar or more, which is provided by a pump (in the case of a liquid) or a compressor (in the case of a gas). The pressurized cleaning fluid is sprayed through the cleaning nozzle onto the surface to be cleaned and can reach a discharge velocity of 36 km/h (equivalent to 10 m/s). Due to the favored position of the cleaning nozzle outside the field of view of the environment sensor and the associated improved cleaning effect, the at least one cleaning nozzle is normally disposed in such a manner that a main discharge direction of the cleaning nozzle is oriented at an angle to the optical axis of the environment sensor. When the cleaning device is used while the vehicle is moving, this oblique orientation, in particular, can have the effect that at least part of the cleaning fluid is blown away by the headwind and possibly by any additional ambient wind and no longer strikes the surface to be cleaned at high vehicle speeds. This has a negative impact on the cleaning efficiency of the cleaning device. Instead, the cleaning fluid is deflected by the headwind and no longer strikes the see-through area or only strikes it insufficiently; the steeper the angle between the main discharge direction and the optical axis of the environment sensor is selected, the stronger this negative effect becomes.

In addition, the known forms of cleaning nozzles in the prior art are often driven by pure functionality, without paying attention to a design and/or styling, i.e., an external appearance, of the overall vehicle that is advantageous for the customer. For example, known cleaning nozzles often lead to an aerodynamically disadvantageous impact on the overall vehicle, as the individual cleaning nozzles often act as aerodynamic interference contours on the outer skin of the vehicle. In addition, known positions of cleaning nozzles often lead to a negative impact on the cleaning performance due to the air flow that occurs when the vehicle is in motion. These disadvantages are particularly pronounced when the cleaning nozzles are disposed in the roof area.

### SUMMARY

Due to the above-mentioned disadvantages which can occur with conventional cleaning devices, the object of the invention is therefore to propose a roof module which has at least one cleaning nozzle and which avoids the above-described disadvantages of the previously known state of the art.

This object is attained by a roof module according to the teaching of claim 1.

Advantageous embodiments of the invention are the subject of the dependent claims.

The roof module according to the invention for forming a vehicle roof on a motor vehicle comprises a panel component which at least partially forms a roof skin of the vehicle roof, the roof skin serving as an outer sealing surface of the roof module. The roof module comprises at least one environment sensor configured to send and/or receive electromagnetic signals through a see-through area around an optical axis of the environment sensor to detect a vehicle environment. Furthermore, the roof module comprises at least one cleaning nozzle configured to clean the see-through area. The roof module according to the invention is characterized in that at least one flow guiding element is disposed on the panel component, the flow guiding element being configured to deflect headwind (and possibly additional (partly turbulent) ambient wind) from the see-through area.

The at least one flow guiding element can basically have any geometric shape, which is preferably designed to guide a flow (in this case headwind) along a predetermined contour of the flow guiding element in such a manner that the flow is guided along the contour and leaves the contour in a predetermined release area in a tangential direction (viewed in relation to the contour in the release area). In principle, the roof module can have one or more flow guiding elements. Herein, a flow guiding element is understood to mean any type of body that is designed to guide a flow in a certain direction. The flow guiding element can be understood in the manner of a spoiler, for example.

Instead of designing a cleaning nozzle with a higher discharge velocity, for which an increase in nozzle pressure appears to be necessary in principle, an optimization of the cleaning effect can be achieved according to the invention with an unchanged cleaning nozzle. This is because at least one flow guiding element configured to deflect the headwind (and any additional (partly turbulent) ambient wind) away from the see-through area is provided according to the invention. This means that known cleaning nozzles can still be used.

In principle, the solution according to the invention is also suitable for retrofit solutions and can, for example, be at least partially combined with existing cleaning nozzles. Since the cleaning fluid is no longer deflected by headwind according to the invention, the cleaning effect of an existing cleaning nozzle can be increased compared to the state of the art. In addition, the solution according to the invention does not require a higher system pressure level, which means that the costs for supply lines, possibly a compressor, possibly a pump and at least one cleaning nozzle do not increase compared to the prior art. Rather, the at least one additional element provided in the form of the flow guiding element deflects the external vehicle flow, i.e., the headwind, in such a manner that the area to be cleaned (i.e., the see-through area, for example) is preferably located in an area where there is no (head) wind.

The flow guiding element allows the cleaning jet of the at least one cleaning nozzle to remain in the slipstream of the vehicle flow in the operating or cleaning state, which means the cleaning jet is not deflected even at a higher vehicle speed. The flow guiding element also creates a virtually wind-free space for the cleaning nozzle while the vehicle is moving, which is essentially similar to a situation that exists when the vehicle is stationary and in a windless environment. The cleaning of the see-through area can therefore preferably always take place in an area of the roof module in which a slipstream created by the flow guiding element prevails, regardless of the speed of travel. In addition, the flow guiding element according to the invention also makes it possible to at least partially dispense with cleaning or at least minimize it, as the deflection of the headwind from the see-through area means that fewer dirt particles and insects reach the see-through area, causing the latter to accumulate less dirt overall. In particular, this minimizes the amount of cleaning fluid required. In other words, the flow guiding element can reduce the accumulation of rainwater and dirt on the see-through area, for example. The principle according to the invention, which is achieved by the flow guiding element, can in principle be used both for liquid-based cleaning and for gas-based cleaning in an unrestrictedly effective manner.

The at least one flow guiding element according to the invention proves to be particularly effective if the at least one cleaning nozzle, when viewed in the direction of the line of sight of the environment sensor along its optical axis, is disposed to the left and/or to the right of it. A respective main discharge direction of the at least one cleaning nozzle is preferably oriented at an angle (i.e., ≠0°, for example in an angle range of ±55° to 85°) with respect to the optical axis. Such a lateral positioning of the at least one cleaning nozzle can be advantageous because, for example, a cross member of the roof frame must be perforated in order to dispose the cleaning nozzle in front of the environment sensor. Furthermore, when viewed along the line of sight of the environment sensor, only a small installation space is required for the at least one cleaning nozzle to be disposed laterally, which is always an advantage. It is particularly preferred for there to be at least two cleaning nozzles, which are disposed on the right and left sides of the panel component at a distance from each other, preferably symmetrically to the optical axis of the environment sensor, outside the field of view of the environment sensor. In this configuration, it is possible on the one hand to form an optimum overlapping area of the fluid cone, as the fluid nozzles can be directed at the see-through area from both sides, preferably with mirror symmetry to the optical axis. On the other hand, it is possible, for example in the case of a large see-through area, to clean one half of the see-through area with one of the two cleaning nozzles and the other half of the see-through area with the other of the two cleaning nozzles. This lateral positioning is also preferred, as the cleaning nozzles are preferably not disposed in a field of view of the environment sensor and therefore do not negatively affect the detection of the vehicle environment. When the at least one cleaning nozzle is disposed laterally in this manner, the cleaning effect of the flow guiding element according to the invention is also improved particularly greatly since in normal cases (i.e., without a flow guiding element according to the invention) the cleaning fluid is particularly strongly influenced or deflected by head and ambient wind (in particular at a high vehicle speed) due to the oblique angle in the case of such a lateral positioning. This can be avoided by the flow guiding element.

Furthermore, the flow guiding element according to the invention is particularly advantageous if it is disposed on the outer side of the panel component since a transverse stiffening of the vehicle roof or the panel component is not adversely affected by holes (e.g., in a cross member or similar, as would be necessary for nozzles). In the simplest case, the flow guiding element can, for example, be glued, soldered or welded onto the panel component, this type of attachment being particularly suitable for a retrofit.

The term “at least one environment sensor” means that the roof module can comprise one or more environment sensors. The term “at least one cleaning nozzle” means that the roof module can comprise one or more cleaning nozzles. A field of view of the environment sensor preferably extends symmetrically around the optical axis of the environment sensor in the form of a cone with a sensor-specific cone opening angle.

Preferably, the roof module comprises at least two cleaning nozzles disposed at a distance from each other on the panel component (preferably also in a retractable and extendable manner). For the purpose of cleaning, the roof module can further have one or more hose lines and/or a tank for cleaning fluid or cleaning gas. Alternatively, it is also possible for a tank provided in a vehicle for cleaning fluid for cleaning the front and rear windows to be used as a reservoir for the cleaning fluid.

The roof module according to the invention can form a structural unit in which devices for autonomous or semi-autonomous driving supported by driver assistance systems are integrated and which can be mounted as a unit on top of a vehicle carcass by a vehicle manufacturer. Furthermore, the roof module according to the invention can be designed as a purely fixed roof or as a roof including a roof opening system. In addition, the roof module can be designed for use in a passenger car or in a commercial vehicle. The roof module can preferably be provided as a structural unit in the form of a roof sensor module (RSM), in which the environment sensors are provided, in order to be inserted into a roof frame of a vehicle body as a deliverable structural unit.

The environment sensor of the roof module according to the invention can basically be designed in a variety of ways and in particular comprise a lidar sensor, a radar sensor, an optical sensor, such as a camera, and/or the like. Lidar sensors, for example, operate in a wavelength range of 905 nm or about 1550 nm. The material of the roof skin in the see-through area should be transparent for the wavelength range used by the environment sensor and should therefore be selected as a function of the wavelength(s) used by the environment sensor.

In a preferred embodiment, the at least one environment sensor, when viewed in the direction of travel, is disposed in a front, preferably middle, area of the roof skin. A line of sight of the environment sensor is preferably oriented essentially (±10%) in the direction of travel. In this embodiment, the at least one cleaning nozzle, when viewed along the line of sight of the environment sensor, is disposed toward the front in front of the see-through area, and the at least one flow guiding element, when viewed along the line of sight of the environment sensor, is disposed toward the front in front of the at least one cleaning nozzle. This embodiment serves in particular to clarify respective relative positions of the environment sensor relative to the cleaning nozzle and of the cleaning nozzle relative to the flow guiding element. In the case at hand, the environment sensor is preferably disposed in a front area (in relation to the direction of travel) of the roof module, for example behind the front roof rail (of the roof module), which defines a front header. The cleaning nozzle is disposed toward the front in front of the see-through area of the environment sensor and is preferably positioned to the right and/or left (viewed in the line of sight) of the see-through area. So the cleaning nozzle preferably has a smaller distance to the front roof rail than the see-through area of the environment sensor. The flow guiding element is disposed in front of the cleaning nozzle. The flow guiding element preferably has a smaller distance to the front roof rail than the cleaning nozzle. In this configuration, the flow guiding element therefore preferably forms a roof-side front spoiler. When the flow guiding element is disposed in this manner, headwind can be deflected in such a manner that the front environment sensor together with the at least one cleaning nozzle is preferably disposed in the slipstream.

In a preferred embodiment, the at least one environment sensor, when viewed in a direction of travel, is disposed in a rear, preferably middle, area of the roof skin. When disposed in this way, a line of sight of the environment sensor is preferably oriented essentially (±10%) opposite the direction of travel. The at least one cleaning nozzle, when viewed along the line of sight of the environment sensor, is disposed toward the rear in front of the see-through area. The at least one flow guiding element, when viewed along the line of sight of the environment sensor, is disposed behind the at least one environment sensor. Depending on the roof module, this embodiment can be present alternatively or additionally. For example, one environment sensor can be disposed in the front on the roof module and another environment sensor can be disposed in the rear on the roof module. This embodiment serves in particular to clarify respective relative positions of the environment sensor in relation to the cleaning nozzle and of the environment sensor in relation to the flow guiding element. The environment sensor is preferably disposed in a rear area of the roof module (in relation to the direction of travel), for example behind the rear roof rail, which defines a rear header. The cleaning nozzle is disposed toward the rear in front of the see-through area of the environment sensor in the direction of the line of sight of the environment sensor and is preferably positioned to the right and/or left of the latter (viewed along its line of sight). The cleaning nozzle therefore preferably has a smaller distance to the rear roof rail than the see-through area of the environment sensor. The flow guiding element is disposed toward the rear in front of the environment sensor when viewed in the direction of travel. In this configuration, the flow guiding element therefore preferably forms a roof-side rear spoiler. The flow guiding element preferably has a greater distance to the rear roof rail (of the roof module) than the environment sensor. The flow guiding element is therefore disposed more toward a center of the roof module or the panel component. When the flow guiding element is disposed in this manner, the headwind can be deflected in such a manner that the rear environment sensor together with the at least one cleaning nozzle is preferably disposed in the slipstream.

In a preferred embodiment, the at least one environment sensor, when viewed in a direction of travel, is disposed in a rear corner area of the roof skin. In this configuration, the environment sensor has a line of sight opposite and at an angle to the direction of travel. The at least one cleaning nozzle, when viewed along the line of sight of the environment sensor, is disposed toward the rear in front of the see-through area in the rear corner area. The at least one flow guiding element, when viewed in the direction of travel, is disposed in a lateral area of the roof skin, preferably in the area of a side rail of the roof module in front of the at least one environment sensor. The term “at an angle” is understood here to mean an orientation deviating from 0°, i.e., not parallel to the direction of travel. For example, the environment sensor can be oriented at an angle of ±90°, preferably ±45°, with respect to the direction of travel. Depending on the roof module, this embodiment may be present alternatively or additionally. The cleaning nozzle is disposed in front of the see-through area of the environment sensor along the line of sight of the environment sensor and is preferably positioned to the right and/or left of the latter (viewed in its line of sight) and preferably laterally directed at it. So the cleaning nozzle preferably has a smaller distance to the respective side rail or rear rail than the see-through area of the environment sensor. When viewed in the direction of travel, the flow guiding element is disposed in front of the environment sensor in the area of the respective side rail. In this configuration, the flow guiding element therefore preferably forms a roof-side side spoiler and preferably protrudes laterally beyond the roof module in a vehicle width direction y. The flow guiding element preferably has a smaller distance to the front roof rail (of the roof module) than the environment sensor. So the flow guiding element is disposed closer to the front roof rail of the roof module or the panel component. When the flow guiding element is disposed in this manner, the headwind can be laterally deflected in such a manner that the laterally disposed environment sensor together with the at least one cleaning nozzle is preferably disposed in the slipstream.

In a preferred embodiment, the at least one environment sensor, when viewed in a direction of travel, is disposed in a lateral area of the roof skin. A line of sight of the environment sensor is oriented at an angle to the direction of travel. The at least one cleaning nozzle, when viewed along the line of sight of the environment sensor, is disposed laterally in front of the see-through area in the lateral area (of the respective side rail of the roof module). The at least one flow guiding element, when viewed in the direction of travel, is disposed in front of the at least one environment sensor in a lateral area of the roof skin. The term “at an angle” is understood here to mean an orientation of the environment sensor in which the optical axis is preferably essentially (±20%) orthogonal to the direction of travel. Depending on the roof module, this embodiment may be present alternatively or additionally. The environment sensor is preferably disposed in a lateral area of the roof module (in relation to the direction of travel), for example offset relative to the side rail in the direction of a center of the roof module. The cleaning nozzle is disposed in front of the see-through area of the environment sensor along the line of sight of the environment sensor and is preferably positioned to the right and/or left of the latter (viewed in its line of sight) and preferably directed laterally at the latter. So the cleaning nozzle preferably has a smaller distance to the respective side rail than the see-through area of the environment sensor. When viewed in the direction of travel, the flow guiding element is disposed in front of the environment sensor in the area of the respective side rail. In this configuration, the flow guiding element therefore preferably forms a roof-side side spoiler and preferably protrudes laterally beyond the roof module in a vehicle width direction y. The flow guiding element preferably has a smaller distance to the front roof rail (of the roof module) than the environment sensor. So the flow guiding element is disposed closer to the front roof rail of the roof module or the panel component. When the flow guiding element is disposed in this manner, the headwind can be deflected laterally in such a manner that the laterally disposed environment sensor together with the at least one cleaning nozzle is preferably disposed in the slipstream.

In a preferred embodiment, the at least one flow guiding element on the roof skin is disposed rigidly (i.e., fixed and immovable) relative to the roof skin or is formed by the roof skin itself. So the flow guiding element can preferably be glued, soldered or welded to the roof skin or connected to the roof skin in some other way (e.g., screwed, riveted or bolted). This has the particular advantage that the flow guiding element can also be retrofitted to the roof skin. This has great advantages for retrofitting, as existing cleaning devices can be upgraded with the flow guiding element according to the invention. Alternatively or additionally, the flow guiding element can also be formed by the roof skin or the panel component itself, in which case a contour and/or shape of the flow guiding element (e.g., as a negative in the original form) must already be defined during manufacture (e.g., during deep drawing) of the panel component. This integral design of the flow guiding element has the advantage that no additional components are required that need to be installed; instead, the flow guiding element can be formed directly during manufacture.

In a preferred embodiment, the at least one flow guiding element can be moved between a retracted position and at least one deployed position by a drive. The retractability and deployability of the at least one flow guiding element has the advantage that the flow guiding element does not always protrude above the panel component but can only be deployed for cleaning when the at least one cleaning nozzle is in use. For example, the at least one flow guiding element may not be extended until a certain vehicle speed is reached, above which a deflection of the cleaning fluid by headwind adversely affects the cleaning effect. The retractability and deployability improves the visual appearance, i.e., styling, of the roof module and the motor vehicle in particular, as the “visual interference contours” caused by the at least one flow guiding element only affect the appearance of the motor vehicle during the cleaning process. The flow guiding element may also be moved to different deployed positions (between the retracted position and a maximum deployed position) as a function of speed and/or a predetermined cleaning program, for example to enable speed-optimized deflection of the headwind. The drive can, for example, comprise an electric motor and/or a hydraulic and/or a pneumatic drive and/or a mechanical drive. The drive can also have a Bowden cable and/or a flexible shaft and/or one or more lever elements and/or a single-stage or multi-stage gear mechanism and/or a return spring and/or similar.

In a preferred embodiment, the drive can be activated by the at least one cleaning nozzle. In this embodiment, the cleaning nozzle can transmit a signal to the drive when a cleaning process is started, for example, which causes the drive to deploy the at least one flow guiding element. Alternatively or additionally, the at least one cleaning nozzle is also able to be retracted and deployed. When the cleaning nozzle is deployed to start a cleaning process, a signal can then be generated and transmitted to the drive, causing the drive to deploy the at least one flow guiding element. It is also conceivable in principle that the at least one cleaning nozzle and the at least one flow guiding element share a common drive and can therefore be retracted and deployed at the same time or at different times (e.g., by means of a manual gear mechanism). In other words, the at least one cleaning nozzle can preferably be configured to directly or indirectly control the retraction and deployment of the flow guiding element.

In a preferred embodiment, the at least one cleaning nozzle is integrated in the at least one flow guiding element and/or disposed on the at least one flow guiding element. Preferably, the at least one flow guiding element at least externally acts as a wind deflector and/or as a wind guiding element and/or as a spoiler. The flow guiding element can preferably be designed as a cover element. According to a preferred embodiment, the at least one cleaning nozzle is directly attached to the flow guiding element and/or indirectly attached to the flow guiding element, in particular by means of a support profile. Alternatively or additionally (and/or), the at least one cleaning nozzle is molded onto and/or injected into and/or overmolded onto the flow guiding element. The molding and/or overmolding and/or injection can preferably be carried out by means of injection molding. Alternatively or additionally, the at least one cleaning nozzle can be comprised by the flow guiding element. The at least one cleaning nozzle can, for example, be inserted into the flow guiding element, meaning the flow guiding element forms a housing of the at least one cleaning nozzle. If the flow guiding element is integral with the roof skin, the cleaning nozzle can then be easily inserted into such a flow guiding element. A design as a separate component is also preferred, in which case preferably at least part of a housing of the at least one cleaning nozzle functions as the at least one flow guiding element. A cleaning nozzle designed in this manner can be configured to be retractable and deployable together with the flow guiding element. In other words, the at least one cleaning nozzle together with the flow guiding element can be adjustable between a retracted position and at least one deployed position. This embodiment is particularly space-saving, as the flow guiding element does not have to be disposed separately and spaced apart from the at least one cleaning nozzle. Preferably, at least part of a housing may form a headwind spoiler when the at least one cleaning nozzle is in the deployed state, the headwind spoiler being configured to deflect headwind away from the see-through area. In other words, the at least one housing of the at least one cleaning nozzle is folded out, i.e., deployed, during cleaning and at least partially forms a spoiler (the flow guiding element) which deflects the headwind. As a result, the spray field or the spray cone of the at least one spray nozzle is less influenced by the headwind and less influenced by any prevailing ambient wind. Instead, the headwind and/or the ambient wind is deflected by the spoiler so that it no longer strikes the see-through area directly but is preferably deflected to the side and above the see-through area. This means that the spray cone is less affected by the wind with the result that a better cleaning effect can be achieved. For this purpose, the housing, e.g., the lid part and or side walls of the housing can be aerodynamically shaped and have, for example, one or more curvatures, channels, air guiding gaps and/or other shaping elements. The aerodynamic shaping of the housing may be provided by one or more components that may be mounted on the housing. Alternatively, the aerodynamic shaping can also be provided by the integral design of the housing.

According to a preferred embodiment, the at least one flow guiding element at least externally acts as a wind deflector and/or as a wind guiding element and/or as a spoiler. This can have a positive effect on the aerodynamic shape of the vehicle as a whole. In addition, such a solution corresponds to a predetermined styling and/or design of the overall vehicle. In this embodiment, the at least one cleaning nozzle is particularly preferably disposed on and/or comprised by and/or integrated in the flow guiding element, which is in particular a panel element. Particularly preferably, the at least one cleaning nozzle is mounted on and/or integrated in the flow guiding element, for example, so that the two parts can be supplied as a structural unit. Preferably, at least one seal can be disposed between the flow guiding element and a respective interface to the vehicle. The advantage of this design is that the cleaning nozzle is preferably provided as a standard component and does not itself have to comprise an aerodynamic design itself. The aerodynamic function is then preferably provided by the flow guiding element or at least a part of the panel component or a part of the windshield. This allows the styling of the vehicle to be optimized. The aerodynamics of the vehicle as a whole can be adjusted by selecting and/or designing the appropriate cover. The flow guiding element and/or the panel component and/or the windshield can preferably be configured to cover further connection components of the cleaning nozzle or cleaning nozzles and/or serve(s) as installation space for these components, e.g., valves, hoses, etc.

In a preferred embodiment, the at least one cleaning nozzle is disposed outside a field of view of the environment sensor. The at least one cleaning nozzle is preferably oriented in such a manner relative to the optical axis that a fluid cone that can be generated during cleaning strikes the see-through area with its main discharge direction (its cone axis) at an oblique angle. The see-through area itself can have a curved shape. This embodiment is advantageous because it means that the at least one cleaning nozzle does not adversely affect the environment sensor in detecting the vehicle environment.

Basically any type of environment sensor can be installed in the roof module. The use of lidar sensors and/or radar sensors and/or camera sensors and/or multi-camera sensors is particularly advantageous.

It is understood that the embodiments and embodiment examples mentioned above and to be explained below can be realized not only individually but also in any combination with one another without departing from the scope of the present invention. Moreover, any and all embodiments and embodiment examples of the roof module relate to a motor vehicle comprising such a roof module.

### BRIEF DESCRIPTIONS OF THE DRAWINGS

An embodiment of the invention is schematically illustrated in the drawing and will be explained below by way of example.

FIG. 1 is a perspective view of a vehicle roof with a roof module according to the invention;

FIG. 2 shows a first embodiment example of the roof module according to the invention with a cleaning nozzle integrated into a flow guiding element in a front area of the roof module;

FIG. 3 shows a second embodiment example of the roof module according to the invention with a retractable and deployable flow guiding element and a cleaning nozzle in a front area of the roof module;

FIG. 4 shows a third embodiment example of the roof module according to the invention with a retractable and deployable cleaning nozzle integrated in a flow guiding element together with an adjustment mechanism in a front area of the roof module;

FIG. 5 shows a fourth embodiment example of the roof module according to the invention with two cleaning nozzles disposed laterally relative to a see-through area in a front area of the roof module;

FIG. 6 shows a fifth embodiment example of the roof module according to the invention with a flow guiding element and a cleaning nozzle in a rear area of the roof module;

FIG. 7 shows a sixth embodiment example of the roof module according to the invention with a flow guiding element and a cleaning nozzle in a rear corner area of the roof module;

FIG. 8 is a comparative illustration showing a comparison between cleaning with a flow guiding element and without a flow guiding element;

FIG. 9 shows a schematic embodiment of a flow guiding element;

FIG. 10 shows a schematic embodiment of a flow guiding element;

FIG. 11 shows a schematic embodiment of a flow guiding element;

FIG. 12 shows a schematic embodiment of a flow guiding element; and

FIG. 13 shows a schematic embodiment of a flow guiding element.

### DETAILED DESCRIPTION

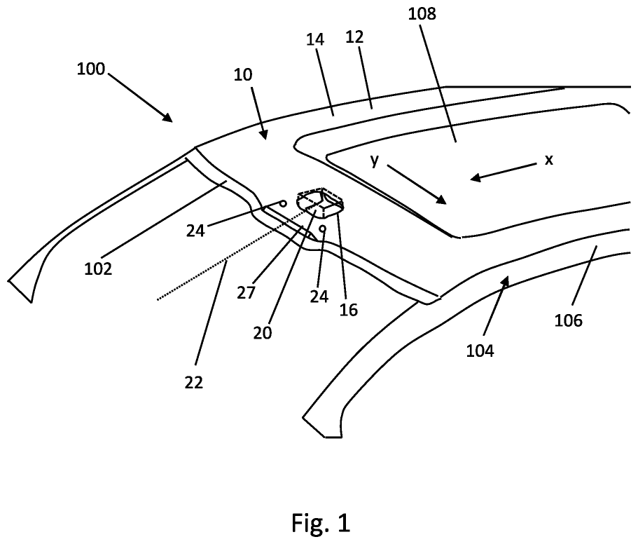

FIG. 1 shows a vehicle roof 100 of a vehicle (not shown in its entirety), which comprises a roof module 10. The roof module 10 is preferably inserted as a structural unit into a roof frame 104 of the vehicle or placed on top of the at least two transverse rails 102 and at least two longitudinal rails 106 of the vehicle body which form the roof frame 104. The roof module 10 in the embodiment example shown has a panoramic roof 108.

The roof module 10 comprises a panel component 12 for forming a roof skin 14 of the vehicle roof 100. An environment sensor 16 is disposed symmetrically to the longitudinal axis of the vehicle in a front area of the vehicle roof 100 or the roof module 10 (viewed in a longitudinal vehicle direction x, which corresponds to a direction of travel of the motor vehicle). The environment sensor 16 is disposed directly behind a front transverse rail 102, which defines a roof-side header adjacent to a windshield (not shown) of the vehicle. The environment sensor 16 can be retractable and deployable or disposed on the panel component 12 in a rigid manner. In the present case, the environment sensor 16 is disposed in an interior of the roof module 10 and covered by the panel component 12. The environment sensor 16 is disposed in a sensor housing 18, which forms a dry area in which the environment sensor 16 is disposed in a moisture-proof manner. The environment sensor 16 is a lidar sensor in the present case. However, other sensor types, e.g., (multidirectional) cameras, which are used in (partially) autonomous driving, can also be used.

The roof module 10 comprises a see-through area 20, which can be made, for example, from a preferably shatterproof plastic, glass or other (partially) transparent material. The environment sensor 16 is oriented along an optical axis 22, which in the case of FIG. 1 is aligned parallel to the longitudinal vehicle direction x. A field of view 23 of the environment sensor 16, in which the environment sensor 16 can send and/or receive electromagnetic signals in order to detect a vehicle environment, extends conically around the optical axis. In the present case, the see-through area 20 is disposed in the panel component 12 and embedded it in the manner of a window, for example. The see-through area 20 is curved in the present case and adapts to the shape of the surrounding panel component to create a flush contour.

The roof module 10 further comprises at least one cleaning nozzle 24 configured to clean the see-through area 20. FIGS. 1, 5, 7 and 8 show the roof module 10 with two cleaning nozzles 24, each of which is supplied with a cleaning fluid (e.g., a liquid or a gas) through a supply duct (not shown). When viewed along a line of sight of the environment sensor 16, the two cleaning nozzles 24 are positioned to the right and left of the environment sensor 16 outside the conical field of view 23 in front of the see-through area 20 and preferably have an angled position relative to each other so that the see-through area 20 can be cleaned from two different directions. The cleaning fluid can be an aqueous soapy solution, for example. Alternatively, cleaning with compressed air or another pressurized gas is also conceivable. When the cleaning fluid is discharged from the cleaning nozzles 24, respective fluid cones 26 are generated which strike the see-through area 20 and clean it (see FIG. 5). The fluid cones 26 can preferably at least partially overlap in an area of overlap of the see-through area 20 (see FIGS. 5 and 7).

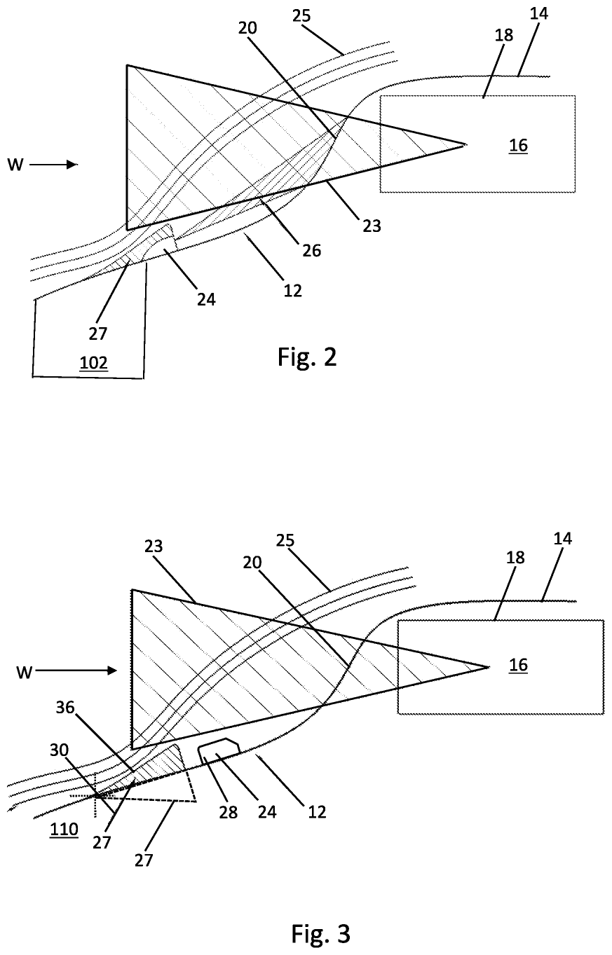

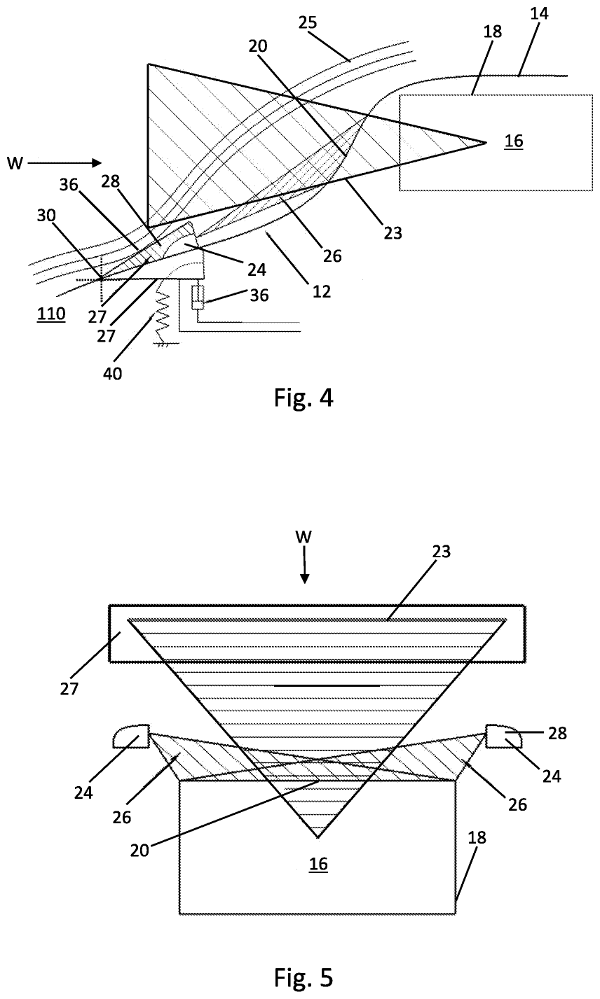

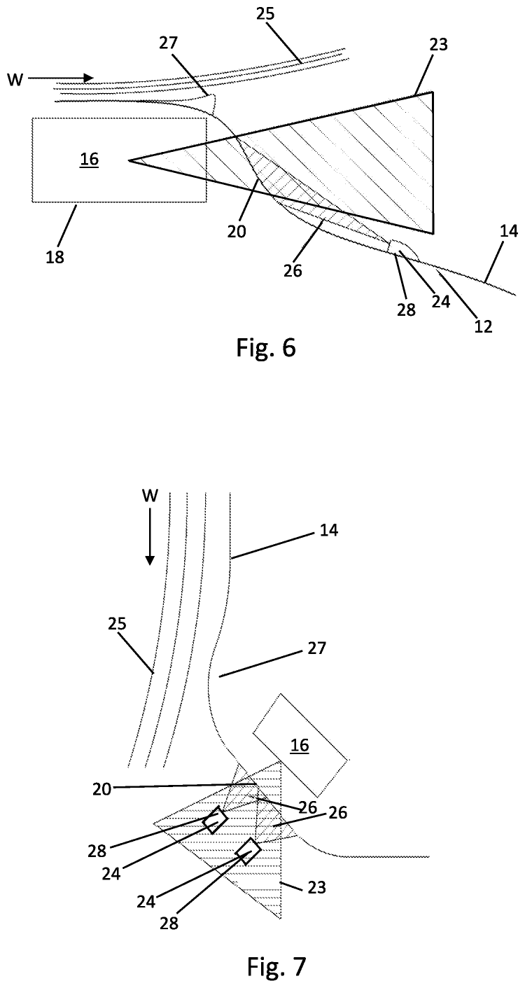

According to the invention, the roof module 10 has at least one flow guiding element 27, which is disposed rigidly on the panel component 12 (see FIGS. 2 and 6) or in such a manner that it can be retracted or deployed (see FIGS. 3 and 4) or is integrally formed by the panel component 12 (see FIG. 7). The flow guiding element 27 makes it possible to deflect headwind W from the see-through area 20 so that the fluid cone 26 of the cleaning nozzle 24 in question is no longer affected by the headwind W. So a deflected flow 25 is caused, which is essentially influenced by a flow contour of the flow guiding element 27. The flow guiding element 27 can basically have any geometric design. For example, the flow guiding element 27 can have an elongated wedge shape (see FIGS. 1 to 5 in partially different views of the wedge), a curved wedge shape (see FIG. 6) or can also be shaped as a curved outer contour of a lateral area of the roof module 10 (see FIG. 7).

The cleaning nozzle 24 can be integrated in the flow guiding element 27, in which case the flow guiding element 27 forms a housing 28 of the cleaning nozzle 24 (see FIGS. 2 and 4). The housing 28 or the flow guiding element 27 can be rigidly disposed on the panel component 12 together with the integrated, e.g., inserted, cleaning nozzle 24, as in FIG. 2. In principle, the cleaning nozzle 24 can also be disposed at a distance from the flow guiding element 27 in its own housing 28 (see FIGS. 5 to 8). Alternatively or additionally, one of the flow guiding elements 27 can also, for example, be movably mounted on the frame structure 110 or be movably supported thereon so that the flow guiding element 27 together with the at least one cleaning nozzle 24 can be moved between a retracted position and at least one deployed position (see both positions in FIG. 4). It is also possible for the flow guiding element 27 to be retractable and deployable without an integrated cleaning nozzle 24, as shown in FIG. 3. According to FIG. 4, the flow guiding element 27 together with the cleaning nozzle 24 can be rotated between the retracted position and the deployed position about an axis of rotation 30.

The mobility between the retracted position and the deployed position is provided by a drive 34. An exemplary drive 34 is shown schematically in FIG. 4. The drive 34 makes it possible to adjust the flow guiding element 27 in such a manner that at least a lid part 36 of the flow guiding element 27 or also a lid part 36 of the housing 28 (in the event that the cleaning nozzle 24 is integrated in the flow guiding element 27) is flush with the outer surface of the roof skin 14 of the vehicle roof in the retracted position (see respective positions in FIGS. 3 and 4). In the deployed position of the at least one flow guiding element 27, on the other hand, the flow guiding element 27 protrudes at least partially above the outer surface of the roof skin 14 of the vehicle roof 100 so that the flow guiding element acts as a (head) wind spoiler in the deployed state, by means of which the headwind W can be deflected away from the see-through area 20. By deflecting the headwind W, the see-through area 20 can be cleaned more effectively, as the cleaning process is no longer affected by headwind or ambient wind which might blow the cleaning fluid away might, for example.

In the case of FIG. 4, the drive 34 comprises a pneumatic drive 38, which can be a pressure control valve, for example. Furthermore, the flow guiding element 27 is preloaded into one of the positions (i.e., into either the retracted position or the deployed position) by a preload spring 40, meaning the drive 38 has to generate a counterforce against the preload spring 40 to move it to the other position. The flow guiding element 27 is then returned to the preloaded starting position without the drive 38 by the restoring force of the preload spring 40. Other types of drives are also conceivable in principle and can be advantageous depending on the configuration of the roof module 10.

To summarize, FIG. 2 shows the flow guiding element 27 with an integrated cleaning nozzle 24 disposed rigidly on the panel component 12. When viewed in the direction of travel x, the environment sensor 16 is disposed under the roof skin 14 behind the front transverse rail 102. The flow guiding element 27 is disposed toward the front in front of the environment sensor 16 when viewed along the line of sight of the environment sensor 16.

FIG. 3 shows the flow guiding element 27 in a retractable and deployable configuration. The cleaning nozzle 24 is spaced apart from the flow guiding element 27. When viewed in the direction of travel x, the environment sensor 16 is disposed under the roof skin 14 behind the front transverse rail 102. The cleaning nozzle 24 is disposed toward the front in front of the environment sensor 16 when viewed along the line of sight of the environment sensor 16. The flow guiding element 27 is disposed in front of the cleaning nozzle 24 when viewed along the line of sight of the environment sensor 16.

FIG. 4 shows the flow guiding element 27 with an integrated cleaning nozzle 24 in a retractable and deployable configuration on the panel component 12. When viewed in the direction of travel x, the environment sensor 16 is disposed under the roof skin 14 behind the front transverse rail 102. The flow guiding element 27 together with the cleaning nozzle 24 is disposed toward the front in front of the environment sensor 16 when viewed along the line of sight of the of the environment sensor 16.

FIG. 5 shows a top view of the front area of the roof module 10. When viewed along the line of sight of the environment sensor 16, respective cleaning nozzles 24 are disposed on the right and left sides toward the front in front of the see-through area 20. The flow guiding element 27 is disposed forward of the cleaning nozzles 24 when viewed along the line of sight of the environment sensor 16.

FIG. 6 shows a section of a rear area of the roof module 10. When viewed in the direction of travel x, the environment sensor 16 is disposed in front of the rear transverse rail 102. The flow guiding element 27 is disposed on the roof skin 14 toward the rear in front of the see-through area 20 when viewed in the direction of travel x. The cleaning nozzle 24 is disposed in front of the see-through area 20 when viewed along the line of sight of the environment sensor 16 (which is oriented opposite the direction of travel).

FIG. 7 shows a situation in which the environment sensor 16 is disposed in a rear corner area of the roof module 10. The optical axis 22 of the environment sensor looks at an angle to the direction of travel x. The cleaning nozzles 24 are disposed in front of the see-through area 20 when viewed along the line of sight of the environment sensor 16. The flow guiding element 27 is an integral part of the panel component and, when viewed in the direction of travel, forms a lateral protrusion of the roof module 10 (which widens the roof module 10 in the vehicle width direction y at this point). Due to the flow guiding element 27, the rear corner area essentially remains in the slipstream.

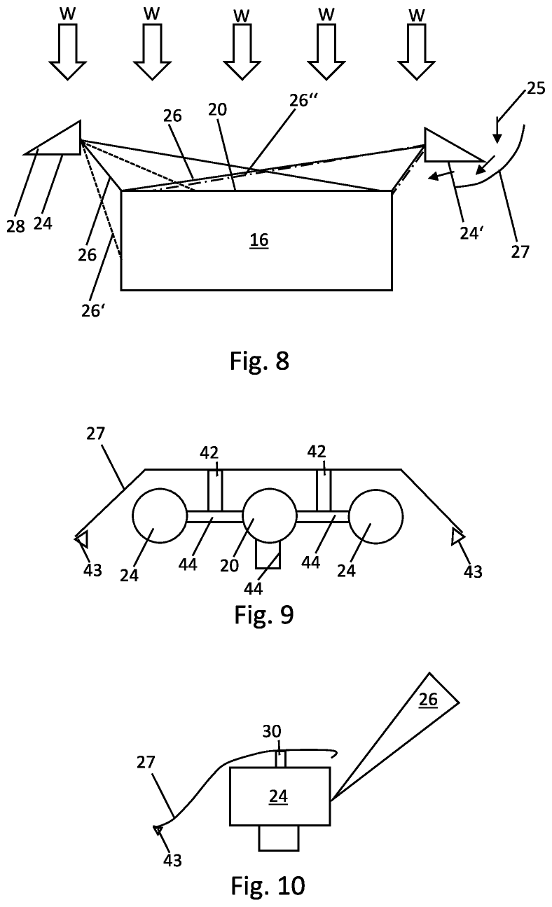

FIG. 8 shows a comparative view between cleaning by a cleaning nozzle 24 when a flow guiding element 27 is used and without a flow guiding element 27 in a top view from above. The environment sensor 16 is disposed in a front area of the roof module 10. An ideal fluid cone 26 of the first cleaning nozzle 24 (on the left-hand side of the figure) is shown with continuous lines. An ideal fluid cone 26 of the second cleaning nozzle 24′ (on the right-hand side of the figure) is also shown with continuous lines. These fluid cones 26 correspond to fluid cones present when the see-through area 20 is cleaned in the absence of wind, i.e., without the influence of headwind W. In comparison, a fluid cone 26′ disturbed by the headwind W is shown with a narrowly dashed line for the first cleaning nozzle 24. As can be seen, the disturbed fluid cone 26′ strikes the see-through area merely in proportion compared to the ideal fluid cone 26, as a result of which the cleaning effect of the first cleaning nozzle 24 decreases. On the left-hand side of the figure, on the other hand, the flow guiding element 27 is disposed. The flow guiding element 27 deflects the headwind away from the see-through area 20, so the see-through area 20 is essentially wind-free. As a result, a fluid cone 26″ (shown as a dash-dot line) is only imperceptibly deflected from its ideal state under the influence of the flow guiding element 27 with the result that the flow guiding element 27 can approximate the cleaning effect to a wind-free optimum case.

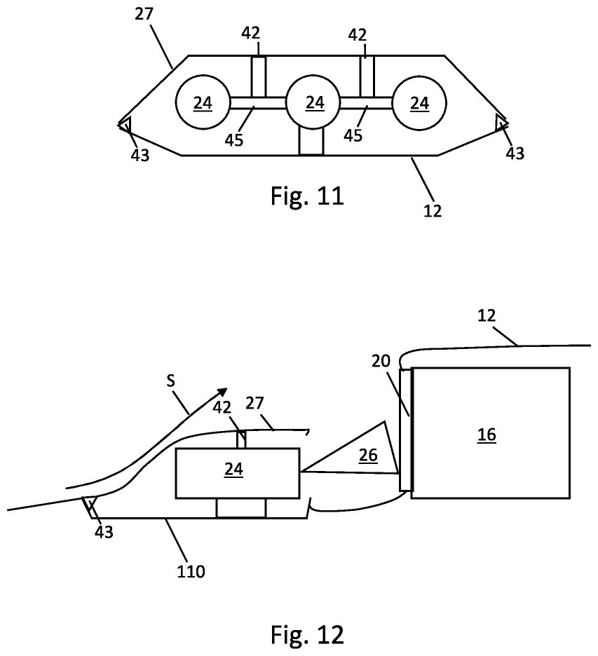

FIGS. 9 to 13 show further embodiment examples of a flow guiding element 27. Here, the flow guiding element 27 at least externally forms a wind deflector and/or a wind guiding element and/or a spoiler. The at least one cleaning nozzle 24 is disposed on the flow guiding element 27 or integrated in it.

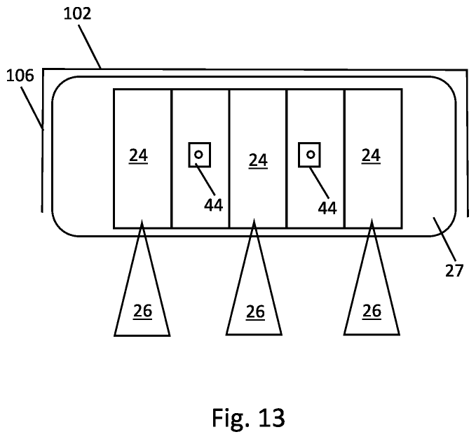

So the flow guiding element 27 effects an aerodynamic optimization of the air flow around the vehicle, as shown schematically in FIG. 12. The flow guiding element 27 acts as a flow guide which deflects a flow S away from the see-through area 20. The see-through area 20 is thus preferably disposed at least in a low-flow area of the roof so that the cleaning effect is not or only slightly influenced by the flow S. The flow guiding element 27 can preferably be connected to the cleaning nozzle 24 via at least one supporting component 42. Alternatively, the cleaning nozzle 24 can also be at least partially integrated in the flow guiding element 27. At least one seal 43, which preferably prevents moisture from entering via the flow guiding element 27, may be disposed between the flow guiding element 27 and the roof rail 102, 106 and/or the panel component 12. A plurality of cleaning nozzles 24 can also be covered by or comprised in the flow guiding element 27 (see FIG. 13 as an example), for example in a series connection. For example, respective valves 44 can be disposed between the individual cleaning nozzles 24. The cleaning fluid is fed to the at least one cleaning nozzle 24 via at least one supply line 45.

The flow guiding element 27 can, for example, be disposed on the panel component 12 or on one of the roof rails, in particular the transverse rail 102 and/or the longitudinal rail 106.

1. A roof module for forming a vehicle roof on a motor vehicle, the roof module comprising:
a panel component, which at least partially forms a roof skin of the vehicle roof, the roof skin serving as an outer sealing surface of the roof module;
at least one environment sensor configured to send and/or receive electromagnetic signals through a see-through area so as to detect a vehicle environment; and
at least one cleaning nozzle configured to clean the see-through area, wherein at least one flow guiding element is disposed on the panel component, the flow guiding element being configured to deflect headwind away from the see-through area.

2. The roof module according to claim 1, wherein the at least one environment sensor, when viewed in the direction of travel x, is disposed in a front, middle, area of the roof skin, and a line of sight of the environment sensor is oriented in the direction of travel, the at least one cleaning nozzle, when viewed along the line of sight of the environment senor, is disposed toward the front in front of the see-through area, and the at least one flow guiding element, when viewed along the line of sight of the environment senor, is disposed toward the front in front of the at least one cleaning nozzle.

3. The roof module according to claim 1, wherein the at least one environment sensor, when viewed in a direction of travel x, is disposed in a rear, middle, area of the roof skin, and a line of sight of the environment sensor is oriented opposite the direction of travel, the at least one cleaning nozzle, when viewed along the line of sight of the environment senor, is disposed toward the rear in front of the see-through area, and the at least one flow guiding element, when viewed along the line of sight of the environment senor, is disposed toward the rear behind the at least one environment sensor.

4. The roof module according to claim 1, wherein the at least one environment sensor, when viewed in a direction of travel x, is disposed in a rear corner area of the roof skin, and a line of sight of the environment sensor is oriented opposite and at an angle to the direction of travel, the at least one cleaning nozzle, when viewed along the line of sight of the environment senor, is disposed toward the rear in front of the see-through area in the rear corner area, and the at least one flow guiding element, when viewed in the direction of travel x, is disposed in front of the at least one environment sensor in a lateral area of the roof skin.

5. The roof module according to claim 1, wherein the at least one environment sensor, when viewed in a direction of travel x, is disposed in a lateral area of the roof skin, and a line of sight of the environment sensor is oriented at an angle to the direction of travel, the at least one cleaning nozzle, when viewed along the line of sight of the environment senor, is disposed laterally in front of the see-through area in the lateral area, and the at least one flow guiding element, when viewed in the direction of travel x, is disposed in front of the at least one environment sensor in a lateral area of the roof skin.

6. The roof module according to claim 1, wherein the at least one flow guiding element is disposed on the roof skin in a rigid manner relative to the roof skin or formed by the roof skin.

7. The roof module according to claim 1, wherein a drive is configured to move the at least one flow guiding element between a retracted position and at least one deployed position.

8. The roof module according to claim 7, wherein the drive is configured to be activated by the at least one cleaning nozzle.

9. The roof module according to claim 7, wherein the drive comprises a hydraulic, pneumatic and/or mechanical drive.

10. The roof module according to claim 1, wherein the at least one cleaning nozzle is integrated in the at least one flow guiding element and/or disposed on the at least one flow guiding element, and/or the at least one flow guiding element at least externally acts as a wind deflector and/or a wind guiding element and/or a spoiler.

11. The roof module according to claim 10, wherein at least part of a housing of the at least one cleaning nozzle serves as the at least one flow guiding element.

12. The roof module according to claim 10, wherein the at least one cleaning nozzle is configured to be moved between a retracted position and at least one deployed position.

13. The roof module according to claim 1, wherein the at least one cleaning nozzle is disposed outside of a field of view of the environment sensor.

14. The roof module according to claim 1, wherein the at least one environment sensor is a lidar sensor and/or a radar sensor and/or a camera sensor and/or a multi-camera sensor.

15. A motor vehicle comprising a roof module according to claim 1.
